(19) United States
(12) Patent Application Publication
(10) Pub. No.: US 2014/0052915 A1
(43) Pub. Date: Feb. 20, 2014

(54) INFORMATION PROCESSING APPARATUS, INFORMATION PROCESSING METHOD, AND PROGRAM

(71) Applicant: SONY CORPORATION, Tokyo (JP)

(72) Inventors: Takamori YAMAGUCHI, Tokyo (JP); Taichi SHIMOYASHIKI, Tokyo (JP); Kazunori YAMAMOTO, Tokyo (JP)

(21) Appl. No.: 13/940,481

(22) Filed: Jul. 12, 2013

(30) Foreign Application Priority Data
Aug. 17, 2012 (JP) 2012180767

(51) Int. Cl. G06F 12/08

(52) U.S. Cl. CPC G06F 12/0802
USPC 711/119

(57) ABSTRACT

An information processing apparatus includes a plurality of cache memories, a plurality of processors configured to respectively access the plurality of cache memories, and a memory, in which each of the plurality of processors executes a program to function as a cache processing unit configured to perform cache processing including at least one of transfer to the memory and discard with respect to all the pieces of data stored in the cache memory.

### BACKGROUND

The present technology relates to an information processing apparatus, an information processing method, and a program, in particular, an information processing apparatus with a period of time used for cache processing can be shortened while a scale of hardware is suppressed in a multiprocessor system provided with plural processors using cache memories, an information processing method, and a program.

Cache processing is conducted when a processor using a cache memory exchanges data with another processor or device via a shared memory. The cache processing includes conducting at least one of transfer to the shared memory and discard with respect to data stored in the cache memory.

In the cache processing, whether or not target data exists in the cache memory is detected, and in a case where the target data exists in the cache memory, at least one of the transfer to the shared memory and the discard is conducted on the data. Therefore, a period of time used for the cache processing is in proportion to a size of the target data.

For this reason, a devisal is proposed in which the cache processing is conducted on all pieces of data stored in the cache memory instead of the target data in a case where the size of the target data for the cache processing is larger than or equal to a size of the cache memory. According to this, the detection as to whether or not the target data exists in the cache memory may be avoided, and the period of time used for the cache processing can be shortened.

On the other hand, a consistency of the pieces of data between the respective cache memories is to be maintained in a multiprocessor system that is provided with plural processors using cache memories. This consistency is generally maintained by hardware.

However, the hardware that does not maintain the consistency of the pieces of data between the respective cache memories exists because of a suppression on a hardware scale or the like in a case where the cache processing is conducted on all the pieces of data stored in the cache memory.

Another devisal is also proposed in which the transfer to the shared memory and the discard are conducted on the data stored in the cache memory only immediately before and immediately after execution of an application program so that the consistency between the cache memory and the shared memory is efficiently managed in a multiprocessor system where image processing is conducted (for example, see Japanese Unexamined Patent Application Publication No. 2008-204292).

### SUMMARY

As described above, the hardware that does not maintain the consistency of the pieces of data between the respective cache memories exists because of the suppression on the hardware scale or the like in a case where the cache processing is conducted on all the pieces of data stored in the cache memory in the multiprocessor system. Therefore, the cache processing is not conducted on all the pieces of data stored in the cache memory in some cases in the multiprocessor system.

Therefore, it is desirable to shorten the period of time used for the cache processing while the scale of the hardware is suppressed by conducting the cache processing on all the pieces of data stored in the cache memory in the multiprocessor system.

The present technology has been made in view of the above-mentioned circumstances, and it is desired to shorten the period of time used for the cache processing in the multiprocessor system while the scale of the hardware is suppressed.

An information processing apparatus according to an embodiment of the present technology includes: a plurality of cache memories; a plurality of processors configured to respectively access the plurality of cache memories; and a memory, in which each of the plurality of processors executes a program to function as a cache processing unit configured to perform cache processing including at least one of transfer to the memory and discard with respect to all the pieces of data stored in the cache memory.

An information processing method according to an embodiment of the present technology includes: causing each of a plurality of processors of an information processing apparatus including a plurality of cache memories, a plurality of processors configured to respectively access the plurality of cache memories, and a memory, to execute a program to perform cache processing including at least one of transfer to the memory and discard with respect to all the pieces of data stored in the cache memory.

A program according to an embodiment of the present technology causes each of a plurality of processors of an information processing apparatus including: a plurality of cache memories; a plurality of processors configured to respectively access the plurality of cache memories; and a memory, to function as a cache processing unit configured to perform cache processing including at least one of transfer to the memory and discard with respect to all the pieces of data stored in the cache memory.

According to an embodiment of the present technology, each of the plurality of processors performs the cache processing including at least one of the transfer to the memory and the discard with respect to all the pieces of data stored in the cache memory accessed by the processor.

According to the embodiment of the present technology, it is possible to shorten the period of time used for the cache processing in the multiprocessor system while the scale of the hardware is suppressed.

### BRIEF DESCRIPTION OF THE DRAWINGS

FIG. 1 is a block diagram illustrating a configuration example of a multiprocessor system serving as an information processing apparatus according to an embodiment to which the present technology is applied;

FIG. 2 illustrates a configuration example of a cache start unit;

FIG. 3 illustrates a configuration example of a total cache processing unit;

FIG. 4 is a flow chart for describing cache start processing; and

FIG. 5 is a flow chart for describing synchronous total cache processing.

### DETAILED DESCRIPTION OF EMBODIMENTS

### Embodiment

### Configuration Example of an Information Processing Apparatus According to an Embodiment

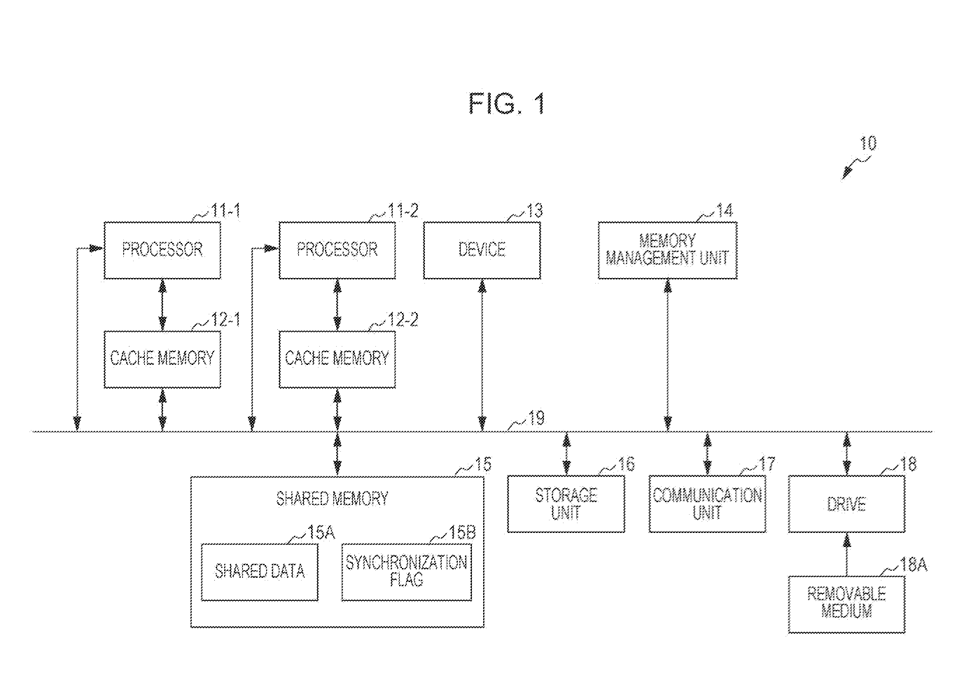

FIG. 1 is a block diagram illustrating a configuration example of a multiprocessor system serving as an information processing apparatus according to an embodiment to which the present technology is applied.

A multiprocessor system 10 of FIG. 1 is configured by connecting a processor 11-1 and a processor 11-2, a cache memory 12-1 and a cache memory 12-2, a device 13, a memory management unit 14, a shared memory 15, a storage unit 16, a communication unit 17, and a drive 18 to each other via a bus (interconnect) 19.

In the multiprocessor system 10, the processor 11-1 (the processor 11-2) executes a program by using the cache memory 12-1 (the cache memory 12-2) and exchanges data with the processor 11-2 (the processor 11-1) and the device 13 via the shared memory 15.

The processor 11-1 and the processor 11-2 are specifically composed of a central processing unit (CPU), a graphics processing unit (GPU), a digital signal processing (DSP), or the like. The processor 11-1 accesses the cache memory 12-1 and executes a program such as an operating system (OS) stored in the storage unit 16.

The processor 11-1 more specifically executes the program to store shared data 15A stored in the shared memory 15 in the cache memory 12-1. The processor 11-1 also executes the program to generate various types of data by using data stored in the cache memory 12-1 as appropriate and stores the generated data in the cache memory 12-1.

The processor 11-1 further executes the OS so perform cache processing on the data stored in the cache memory 12-1. At this time, the processor 11-1 sets a synchronization flag 15B as stop information indicating a stop of the access to the cache memory 12-1 and end information indicating an end of the cache processing as appropriate to be stored in the shared memory 15. The processor 11-1 also performs the cache processing on the basis of the synchronization flags 15B of the processor 11-1 and the processor 11-2 as appropriate.

The processor 11-2 accesses the cache memory 12-2 and executes the program such as the OS stored in the storage unit 16 similarly as in the processor 11-1. In the following description, in a case where the processor 11-1 and the processor 11-2 are not to be particularly distinguished from each other, those are similarly collectively referred to as a processor 11. The cache memory 12-1 and the cache memory 12-2 are similarly collectively referred to as cache memories 12.

The device 13 is a bus master configured to control transfers on the bus 19. The device 13 receives the shared data 15A stored in the shared memory 15 via the bus 19. The device 13 also transmits the data as the shared data 15A to the shared memory 15 to be stored.

The memory management unit 14 controls the cache memories 12 and the dike so that the data consistency between the cache memories 12 except for a case where the cache processing is conducted on all the pieces of data stored in the cache memories 12.

The shared memory 15 stores the data generated by the processors 11 and transferred from the cache memories 12 and the data supplied from the device 13 as the shared data 15A. The shared memory 15 also stores the synchronization flags 15B set by the respective processors 11 in an address space of the processor 11 with a non-cache attribute.

The storage unit 16 is composed of a hard disc, a non-volatile memory, or the like. The storage unit 16 stores the program such as the OS.

The communication unit 17 is composed of a network interface or the like. The drive 18 drives a removable medium 18A such as a magnetic disc, an optical disc, an opto-magnetic disc, or a semiconductor memory.

The program such as the OS can be recorded, for example, in the removable medium 18A serving as a package medium or the like to be provided. The program can also be provided via a wired or wireless transmission medium such as a local area network, the internet, or a digital satellite broadcast.

The program can be installed into the storage unit 16 via the bus 19 by loading the removable medium 18A to the drive 18 in the multiprocessor system 10. The program can also be installed into the storage unit 16 by being received by the communication unit 17 via a wired or wireless transmission medium. In addition, the program can be installed into the storage unit 16 in advance.

It is noted that the program may be a program where the processings are conducted in a time series manner while following the order described in the present specification or a program where the processings are conducted in parallel or at an appropriate timing upon calling or the like.

It suffices if the number of the processors 11 and the number of the cache memories 12 included in the multiprocessor system 10 are plural, and those numbers are not limited to two.

The thus configured processor 11-1 of the multiprocessor system 10 executes the OS to function as a cache start unit configured to perform a notification of a start of the cache processing at a predetermined timing. The processor 11-1 and the processor 11-2 also execute the OS to function as a total cache processing unit configured to perform the cache processing on all the pieces of data stored in the cache memories 12 at a predetermined timing. In the following description, the cache processing on all the pieces of data stored in the cache memories 12 is referred to as total cache processing.

### Configuration Example of a Cache Start Unit

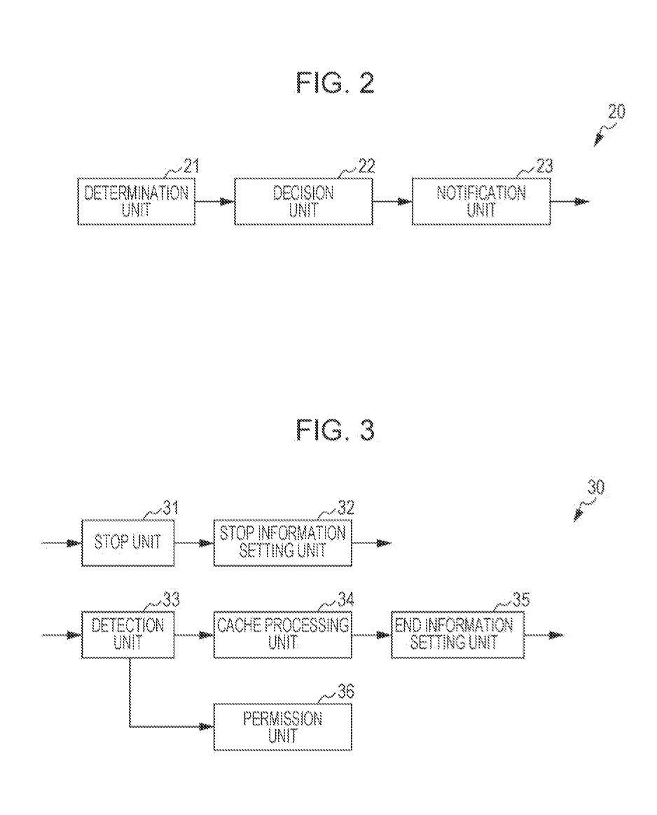

FIG. 2 illustrates a configuration example of a cache start unit 20.

The cache start unit 20 of FIG. 2 is composed of a determination unit 21, a decision unit 22, and a notification unit 23.

The determination unit 21 decides data as a target of the cache processing, for example, when the data is exchanged between the processors 11 and the device 13. The determination unit 21 determines whether or not the total cache processing is conducted on the basis of a size of the data decided as the target of the cache processing and a size of the cache memory 12.

In a case where the determination unit 21 determines that the total cache processing is conducted, the determination unit 21 notifies the decision unit 22 of that effect. On the other hand, in a case where the determination unit 21 determines that the total cache processing is not conducted, the determination unit 21 notifies an individual cache processing unit that is not illustrated in the drawing of that effect. According to this, similarity as in related art, the cache processing is conducted only on the data decided as the target of the cache processing.

The decision unit 22 decides the cache memory 12 to be set as the target of the total cache processing on the basis of an access status to the cache memory 12 after the previous cache processing in accordance with the notification from the determination unit 21.

Specifically, the decision unit 22 decides the cache memory 12 other than the cache memory 12 that is not accessed at all since the previous cache processing as the target of the total cache processing in which at least the transfer to the shared memory 15 is conducted, for example, on the basis of scheduling information of the OS.

In this manner, the decision unit 22 does not decide the cache memory 12 that is not accessed at all since the previous cache processing, that is, the cache memory 12 that may avoid performing the transfer to the shared memory 15 as the target of the total cache processing in which at least the transfer to the shared memory 15 is conducted. Therefore, it is possible to suppress the operation of the processor 11 that may avoid performing the total cache processing in which at least the transfer to the shared memory 15 is conducted, and power consumption can be reduced.

The decision unit 22 may also decide all the cache memories 12 as the target of the total cache processing. The decision unit 22 supplies information for specifying the cache memory 12 set as the target of the total cache processing to the notification unit 23.

The notification unit 23 performs an interrupt with respect to the processor 11 corresponding to the cache memory 12 on the basis of information for specifying the cache memory 12 set as the target of the total cache processing which is supplied from the decision unit 22 so that start of the total cache processing is instructed. The instruction of the start of the total cache processing may also be conducted by another method other than the interrupt.

According to the present embodiment, the processor 11-1 functions as the cache start unit 20, but the processor 11-2 or another processor that is not illustrated in the drawing may also function as the cache start unit 20.

### Configuration Example of a Total Cache Processing Unit

FIG. 3 illustrates a configuration example of a total cache processing unit 30.

The total cache processing unit 30 of FIG. 3 is composed of a stop unit 31, a stop information setting unit 32, a detection unit 33, a cache processing unit 34, an end information setting unit 35, and a permission unit 36.

The stop unit 31 performs processing of stopping the access to the cache memory 12 in accordance with the interrupt from the notification unit 23 of FIG. 2. The stop unit 31 subsequently notifies the stop information setting unit 32 of the stop of the access to the cache memory 12.

The stop information setting unit 32 sets the synchronization flag 15B of the processor 11 as ON in accordance with the notification from the stop unit 31 to set the stop information of the processor 11. The stop information setting unit 32 stores the synchronization flag 15B of the processor 11 that has been set as ON in the shared memory 15 as the stop information of the processor 11.

The detection unit 33 detects the synchronization flags 15B of the processors 11 corresponding to all the cache memories 12 set as the target of the total cache processing (hereinafter, which will be referred to as target processors) which are stored in the shared memory 15. The detection unit 33 notifies the cache processing unit 34 of the completion of the preparation for the total cache processing on all the target processors in a case where the synchronization flags 15B of the target processors are all ON, that is, all pieces of the stop information of the target processors are stored in the shared memory 15.

The detection unit 33 also notifies the permission unit 36 of the end of the total cache processing in all the target processors in a case where the synchronization flags 15B of the target processors are all OFF.

The cache processing unit 34 performs the total cache processing in accordance with the notification from the detection unit 33. In this manner, since the cache processing unit 34 performs the total cache processing in accordance with the notification from the detection unit 33, the total cache processing is not conducted until all the target processors stop the accesses to the cache memories 12.

Therefore, it is possible to avoid an update of the data in the cache memory 12 caused by the access to the cache memory 12 by any of the target processors at the time of the total cache processing. As a result, since the control is not conducted by the memory management unit 14, it is possible to avoid a generation of the data inconsistency between the cache memories 12.

The cache processing unit 34 notifies the end information setting unit 35 of the end of the cache processing when the total cache processing is ended.

The end information setting unit 35 sets the synchronization flags 15B of the processors 11 as OFF in accordance with the notification from the cache processing unit 34 to set the end information of the processors 11. The end information setting unit 35 stores the synchronization flag 15B of the processor 11 which has been set as OFF in the shared memory 15 as the end information of the processors 11.

The permission unit 36 permits the access to the cache memory 12 in accordance with the notification from the detection unit 33. In this manner, since the permission unit 36 permits the access to the cache memory 12 in accordance with the notification from the detection unit 33, the access to the cache memory 12 is not permitted until all the target processors end the total cache processing.

Therefore, it is possible to avoid the update of the data in the cache memory 12 caused by the access to the cache memory 12 after the end of the total cache processing in any of the target processors. As a result, since the control is not conducted by she memory management unit 14, it is possible to avoid the generation of the data inconsistency between the cache memories 12.

### Description on Processing in a Multiprocessor System

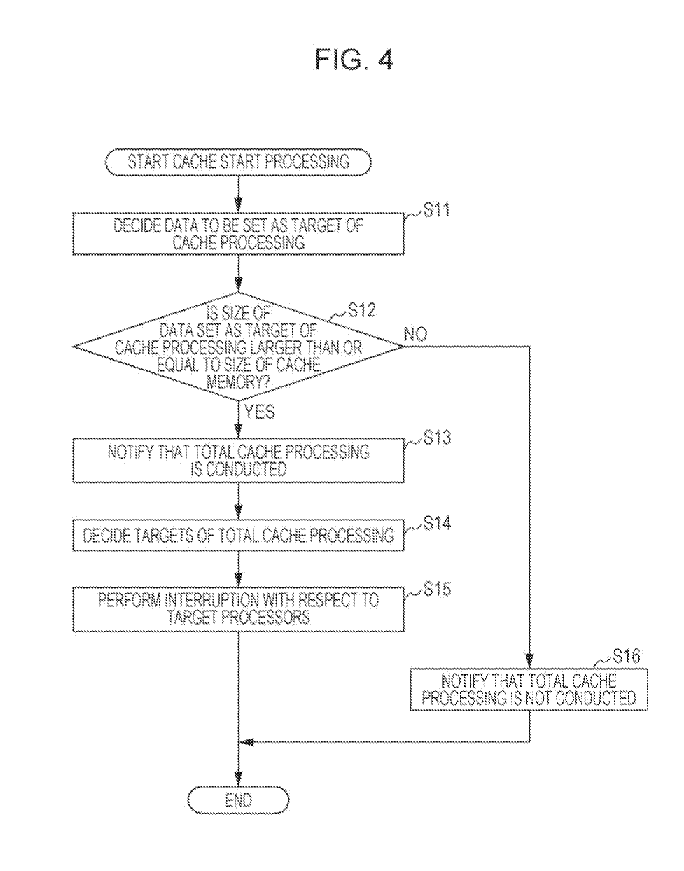

FIG. 4 is a flow chart for describing cache start processing by the cache start unit 20 of FIG. 2. This cache start processing is started, for example, when the data is exchanged between the device 13 and the processors 11.

In step S11, the determination unit 21 decides the data to be set as the target of the cache processing. In step S12, the determination unit 21 determines whether or not a size of the data set as the target of the cache processing is larger than or equal to a size of the cache memory 12.

In step S12, if it is determined that the size of the data set as the target of the cache processing is larger than or equal to the size of the cache memory 12, the determination unit 21 determines that the processing is completed in a shorter period of time when the total cache processing is conducted as compared with a case where the cache processing is conducted only on the data set as the target of the cache processing and determines that the total cache processing is conducted. Subsequently, in step S13, the determination unit 21 notifies the decision unit 22 that the total cache processing is conducted.

In step S14, the decision unit 22 decides she cache memory 12 to be set as the target of the total cache processing on the basis of the access status to the cache memory 12 after the previous cache processing in accordance with the notification from the determination unit 21. The decision unit 22 supplies the information for specifying the cache memory 12 set as the target of the total cache processing to the notification unit 23.

In step S15, the notification unit 23 performs the interrupt with respect to the target processors on the basis of the information for specifying the cache memory 12 set as the target of the total cache processing which is supplied from the decision unit 22, so that the start of the total cache processing is instructed. Then, the processing ends.

On the other hand, in step S12, if it is determined that the size of the data set as the target of the cache processing is not larger than or equal to the size of the cache memory 12, the determination unit 21 determines that the processing is completed in a shorter period of time when the cache processing is conducted only on the data set as the target of the cache processing as compared with a case where the total cache processing is conducted and determines that the total cache processing is not conducted. Subsequently, in step S16, the determination unit 21 notifies the individual cache processing unit that is not illustrated in the drawing that the total cache processing is not conducted, and the processing ends. According to this, the cache processing is conducted only on the data decided as the target of the cache processing similarly as in related art.

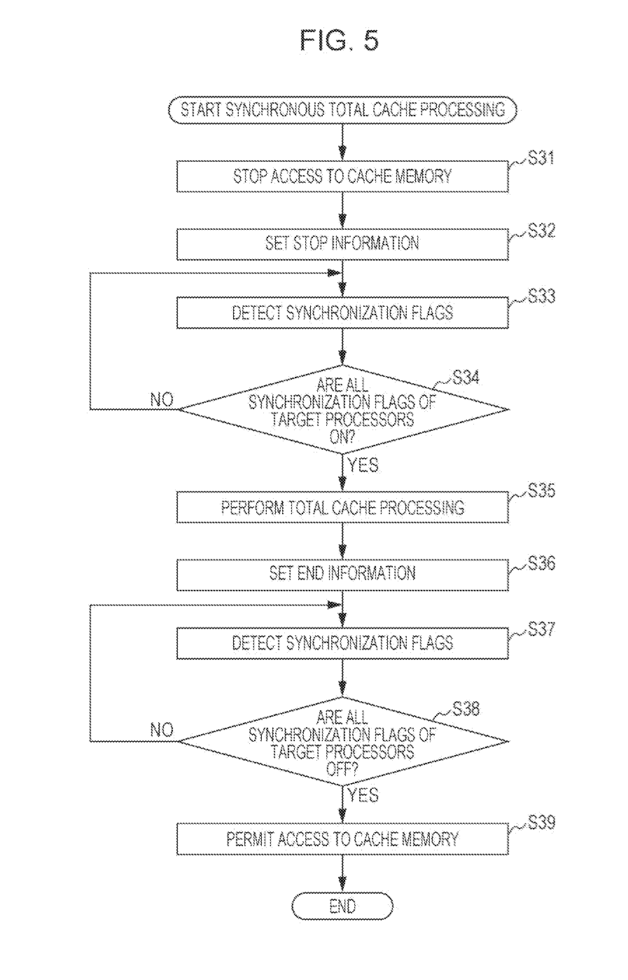

FIG. 5 is a flow chart for describing a synchronous total cache processing by the total cache processing unit 30 of FIG. 3. This synchronous total cache processing is started, for example, when the interrupt from the notification unit 23 of FIG. 2 occurs.

In step S31 of FIG. 5, the stop unit 31 performs processing of stopping the access to the cache memory 12 in accordance with the interrupt from the notification unit 23. Subsequently, the stop unit 31 notifies the stop information setting unit 32 of the stop of the access to the cache memory 12.

In step S32, the stop information setting unit 32 sets the synchronization flag 15B of the processor 11 as ON in accordance with the notification from the stop unit 31 to set the stop information of the processor 11. The stop information setting unit 32 stores the synchronization flag 15B of the processor 11 that has been set as ON in the shared memory 15 as the stop information of the processor 11.

In step S33, the detection unit 33 detects all, the synchronization flags 15B of the target processors stored in the shared memory 15. In step S34, the detection unit 33 determines whether or not the synchronization flags 15B of the target processors are all ON.

In step S34, if it is determined that the synchronization flag 15B of the target processor which is not yet set as ON exists, the processing returns to step S33, and until the synchronization flags 15B of the target processors are all ON, the processing in steps S33 and S34 is repeatedly conducted.

On the other hand, in step S34, if it is determined that the synchronization flags 15B of the target processors are all ON, the detection unit 33 notifies the cache processing unit 34 of the completion of the preparation for the cache processing in all the target processors. Subsequently, in step S35, the cache processing unit 34 performs the total cache processing in accordance with the notification from the detection unit 33. The cache processing unit 34 notifies the end information setting unit 35 of the end of the cache processing when the cache processing is ended.

In step S36, the end information setting unit 35 sets the synchronization flags 15B of the processors 11 as OFF in accordance with the notification from the cache processing unit 34 and sets the end information of the processors 11. The end information setting unit 35 stores the synchronization flags 15B of the processors 11 which have been set as OFF in the shared memory 15 as the end information of the processors 11.

In step S37, the detection unit 33 detects all the synchronization flags 15B of the target processors stored in the shared memory 15. In step S38, the detection unit 33 determines whether or not the synchronization flags 15B of the target processors are set as OFF.

In step S38, if it is determined that the synchronization flag 15B of the target processor which is not yet set as OFF exists, the processing returns to step S37, and until the synchronization flags 15B of the target processors are all OFF, the processing in steps S37 and S38 are repeatedly conducted.

On the other hand, in step S38, if it is determined that the synchronization flags 15B of the target processors are all OFF, the detection unit 33 notifies the permission unit 36 of the end of the cache processing in all the target processors. In step S39, the permission unit 36 permits the access to the cache memory 12 in accordance with the notification from the detection unit 33, and the processing ends.

Since the multiprocessor system 10 performs the total cache processing as described above, it is possible to shorten the period of time used for the cache processing. According to this, for example, in a case where the processors 11 executes an application program for displaying an image in accordance with a user operation, high definition image data is exchanged in a short period of time between the processor 11 and the device 13, and it is possible to shorten a period of time spanning from the user operation to the display.

In contrast to this, for a method of shortening the period of time used for the cache processing, a method is proposed in which a range where the cache processing is to be conducted among a data area is managed by software, and the cache processing is conducted only on the range where the cache processing is to be conducted as a target. However, the software is complicated according to this method, which may lead to a cause of a defect.

The multiprocessor system 10 executes the OS to perform the total cache processing. Therefore, hardware for the total cache processing is not prepared, and a scale of the hardware is suppressed, so that it is possible to realize cost saving and power saving. In addition, since she total cache processing is conducted, an application program in related art is not to be changed.

According to the present embodiment, it is determined whether the total cache processing is conducted on the basis of the size of the data set as the target of the cache processing and the size of the cache memory 12, but the determination may also be made on the basis of information other than the above.

In this case, for example, the total cache processing is conducted in a case where the time used is shorter if the total cache processing is conducted as compared with a case where the cache processing is conducted only on the data decided as the target of the cache processing on the basis of processing performances of the processors 11 and the shared memory 15 or the like.

In addition, the system mentioned in the present specification means an aggregation of plural components (apparatuses, modules (parts), and the like), and all, the components may be or may not be arranged in a same casing. Therefore, plural apparatuses arraigned in separate casings and connected to each other via a network and a single apparatus including plural modules in a single casing are both a system.

Furthermore, the embodiment of the present technology is not limited to the above-mentioned embodiment, and various modifications can be made in a range without departing from the gist of the present technology.

It is noted that the present technology can also adopt the following configurations.

(1) An information processing apparatus including: a plurality of cache memories; a plurality of processors configured to respectively access the plurality of cache memories; and a memory, in which each of the plurality of processors executes a program to function as a cache processing unit configured to perform cache processing including at least one of transfer to the memory and discard with respect to all the pieces of data stored in the cache memory.

(2) The information processing apparatus according to (1), in which each of the plurality of processors executes the program to further function as a stop unit configured to stop an access to the cache memory, and a stop information setting unit configured to set stop information indicating a stop of the access to the cache memory to be stored in the memory in a case where the access to the cache memory is stopped by the stop unit, and in which the cache processing unit performs the cache processing on all the pieces of data stored in the cache memory in a case where the memory stores the stop information of the plurality of processors.

(3) The information processing apparatus according to (1) or (2), in which each of she plurality of processors executes the program to further function as an end information setting unit configured to set end information indicating an end of the cache processing to be stored in the memory in a case where the cache processing unit performs the cache processing, and a permission unit configured to permit the access to the cache memory in a case where the memory stores the end information of the plurality of processors.

(4) The information processing apparatus according to any one of (1) to (3), in which the cache processing unit performs the cache processing on all the pieces of data stored in the cache memory in a case where the cache processing is completed in a shorter period of time when the cache processing is conducted on all the pieces of data stored in the cache memory as compared with a case where the cache processing is conducted only on target data of the cache processing on the basis of a size of the target data and a size of the cache memory.

(5) The information processing apparatus according to any one of (1) to (4), in which the cache processing unit performs the cache processing on all the pieces of data stored in the cache memory on the basis of an access status to the cache memory after the previous cache processing.

(6) The information processing apparatus according to any one of (1) to (5), in which the program is an operating system (OS).

(7) An information processing method including: causing each of a plurality of processors of an information processing apparatus including a plurality of cache memories, a plurality of processors configured to respectively access the plurality of cache memories, and a memory, to execute a program to perform cache processing including at least one of transfer to the memory and discard with respect to all the pieces of data stored in the cache memory.

(8) A program for causing each of a plurality of processors of an information processing apparatus including a plurality of cache memories, a plurality of processors configured to respectively access the plurality of cache memories, and a memory, to function as a cache processing unit configured to perform cache processing including at least one of transfer to the memory and discard with respect to all the pieces of data stored in the cache memory.

The present disclosure contains subject matter related to that disclosed in Japanese Priority Patent Application JP 2012-180767 filed in the Japan Patent Office on Aug. 17, 2012, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An information processing apparatus comprising:
a plurality of cache memories;
a plurality of processors configured to respectively access the plurality of cache memories; and
a memory,
wherein each of the plurality of processors executes a program to function as
a cache processing unit configured to perform cache processing including at least one of transfer to the memory and discard with respect to all the pieces of data stored in the cache memory.

2. The information processing apparatus according to claim 1,
wherein each of the plurality of processors executes the program to further function as
a stop unit configured to stop an access to the cache memory, and
a stop information setting unit configured to set stop information indicating a stop of the access to the cache memory to be stored in the memory in a case where the access to the cache memory is stopped by the stop unit, and
wherein the cache processing unit performs the cache processing on all the pieces of data stored in the cache memory in a case where the memory stores the stop information of the plurality of processors.

3. The information processing apparatus according to claim 1,
wherein each of the plurality of processors executes the program to further function as
an end information setting unit configured to set end information indicating an end of the cache processing to be stored in the memory in a case where the cache processing unit performs the cache processing, and
a permission unit configured to permit the access to the cache memory in a case where the memory stores the end information of the plurality of processors.

4. The information processing apparatus according to claim 1,
wherein the cache processing unit performs the cache processing on all the pieces of data stored in the cache memory in a case where the cache processing is completed in a shorter period of time when the cache processing is conducted on all the pieces of data stored in the cache memory as compared with a case where the cache processing is conducted only on target data of the cache processing on the basis of a size of the target data and a size of the cache memory.

5. The information processing apparatus according to claim 1,
wherein the cache processing unit performs the cache processing on all the pieces of data stored in the cache memory on the basis of an access status to the cache memory after the previous cache processing.

6. The information processing apparatus according to claim 1,
wherein the program is an operating system (OS).

7. An information processing method comprising:
causing each of a plurality of processors of an information processing apparatus including
a plurality of cache memories,
a plurality of processors configured to respectively access the plurality of cache memories, and
a memory, to execute a program to perform cache processing including at least one of transfer to the memory and discard with respect to all the pieces of data stored in the cache memory.

8. A program for causing each of a plurality of processors of an information processing apparatus including
a plurality of cache memories,
a plurality of processors configured to respectively access the plurality of cache memories, and
a memory, to function as
a cache processing unit configured to perform cache processing including at least one of transfer to the memory and discard with respect to all the pieces of data stored in the cache memory.
